(19) United States
(12) Patent Application Publication
(10) Pub. No.: US 2001/0030268 A1
(43) Pub. Date: Oct. 18, 2001

(54) Two prong fastening pin

(76) Inventor: Ward M. Larson, Yukon, OK (US)

Correspondence Address: Rondal D. Homburg, 4th Floor, 50 Penn Place, Oklahoma City, OK, 73118-1803, US

(21) Appl. No.: 09/738,500

(22) Filed: Dec. 18, 2000

Related U.S. Application Data
(60) Provisional application No. 60/177,372, filed on Jan. 24, 2000.

(51) Int. Cl. F16L 3/08

(52) U.S. Cl. 248/74.5; 248/65; 248/71

(57) ABSTRACT

The invention is a two pronged push tack fastening pin having rigid metal wire forming two straddling attaching pins and a weather resisting pin encasement, the device utilized in hanging pictures, as a substitute for a thumb tack, for fastening Christmas lighting, telephone lines, wire cable, water lines, small tubing or any other linear wire, cable or string to walls, baseboards, house siding, facing boards or other surfaces where temporary or permanent installation is desired by using either the pushing force of the user, similar to a thumb tack, or a hammer, similar to a wire brad.

### CROSS REFERENCE TO RELATED APPLICATIONS

Provisional Patent No. 60/177,372 filed on Jan. 24, 2000.

### I. BACKGROUND OF THE INVENTION

1. Field of Invention

The invention is a two pronged push tack fastening pin having rigid metal wire forming two straddling attaching pins and a weather resisting pin encasement, the device utilized in hanging pictures, as a substitute for a thumb tack, for fastening Christmas lighting, telephone lines, wire cable, water lines, small tubing or any other linear wire, cable or string to walls, baseboards, house siding, facing boards or other surfaces where temporary or permanent installation is desired by using either the pushing force of the user, similar to a thumb tack, or a hammer, similar to a wire brad.

2. Description of Prior Art

The following United States patents were discovered and are disclosed within this application for utility patent. All relate to fastening devices, particularly for use with cable or electrical conducting wire.

U.S. Pat. No. 5,695,159 to Adams, U.S. Pat. No. 5,411,228 to Morawa and U.S. Pat. No. 4,903,920 to Merritt, disclose cable securing devices having a formed cable clip which provides for a securing portal for the cable, a hole for application of a nail, and the use of a singular nail for attaching the device to a surface. The Adams patent also provides ears removal with a hammer for reuse. In U.S. Pat. No. 4,801,064 to Mangone, Jr., a cable mounting apparatus for use with a particular attaching gun is provided to attach cable to a surface without deforming the cable and without the risk of penetrating the cable. A plastic clip with an integral driving nail is disclosed in U.S. Pat. No. 4,655,423 to Schavilje.

U.S. Pat. No. 4,988,249 to Kardefeldt, discloses a fastening device for attaching a wire holding device to a porous surface using a V-shaped metal nailing component which tends to spread in an opposing manner when being driven into the porous surface for additional lateral holding support. An improved staple assembly having barbs and pointed protuberances for securing insulated cable using a staple gun is disclosed in U.S. Pat. No. 5,718,548 to Cotellessa. Finally, U.S. Pat. No. 5,967,468 to Veghte discloses a cable retaining clamp which is applied around a cable and then anchored into apertures in the device to which the cable is to be attached by retainer tabs which pass through the apertures, such retainer tabs emanating from the cable retaining clamp.

U.S. Pat. No. 5,370,487 to Kracke discloses atack having a slit to hold flat sheet materials, while U.S. Pat. No. 5,800,109 to Carruthers discloses a fastener with a tapered section and slot which has a ridged taper shaft to securely fit within a hole using thumb pressure until it is hammered into the hole, the invention assisting in the proper alignment during installation. A steady push pin is disclosed in U.S. Pat. No. 4,897,007 to Chen, is a singular pin having a threaded stem and an elliptical cylinder head with a vertical concave periphery surface, the threaded stem providing for better horizontal load holding capacity and better tacking repeatability.

Four design patents to Wagner are disclosed in U.S. Design Pat. Nos. 414,207, D 410,032, D 409,663 and D 428,058, which all indicate a different head shape, but all having a singular push pin. Design Pat. No. D 324,649 to Lederhaus discloses a dual fluted, single shaft push pin with an expanded head. None of these disclosed patents have dual push pins, as does the present invention.

### II. SUMMARY OF THE INVENTION

The primary objective of the invention is to provide a two pronged push tack fastening pin as an improved alternative to a single prong fastener or a conventional thumb tack, the two prong fastener used in hanging pictures, fastening Christmas lighting, telephone lines, wire cable, water lines, small tubing or any other linear wire, cable or string to walls, baseboards, house siding, facing boards or other surfaces where temporary or permanent installation is desired. A second objective is that the invention requires minimal force to apply to a penetrable surface by using the pushing force of the user, similar to a thumb tack, yet be durable enough to withstand the force of a hammer, similar to a wire brad. The third objective is to provide a fastener which is shaped to enhance the ease of removal from the surface to which it is attached by implementing an expanded and contour shaped head which can be removed by finger force without having to pry the head of the fastener from the applied surface.

### III. DESCRIPTION OF THE DRAWINGS

The following drawings are submitted with this utility patent application.

FIG. 1 is a perspective view of the invention.

FIG. 2 is a top view of the invention.

FIG. 3 is a bottom view of the invention.

FIG. 4 is a side view of the invention.

FIG. 5 is a second side view of the invention.

### IV. DESCRIPTION OF THE PREFERRED EMBODIMENT

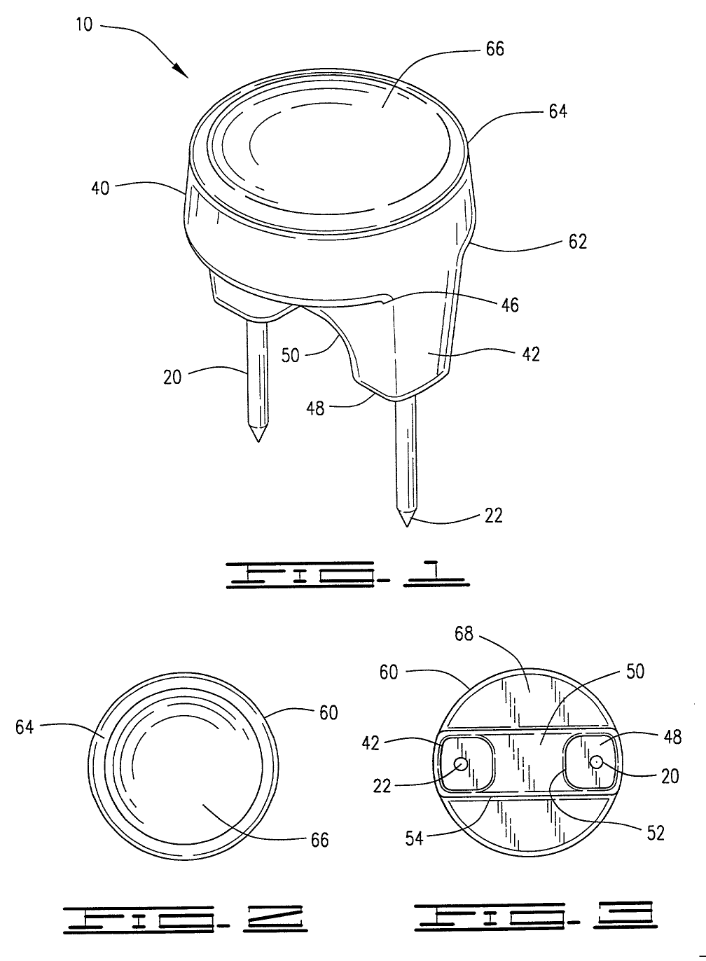

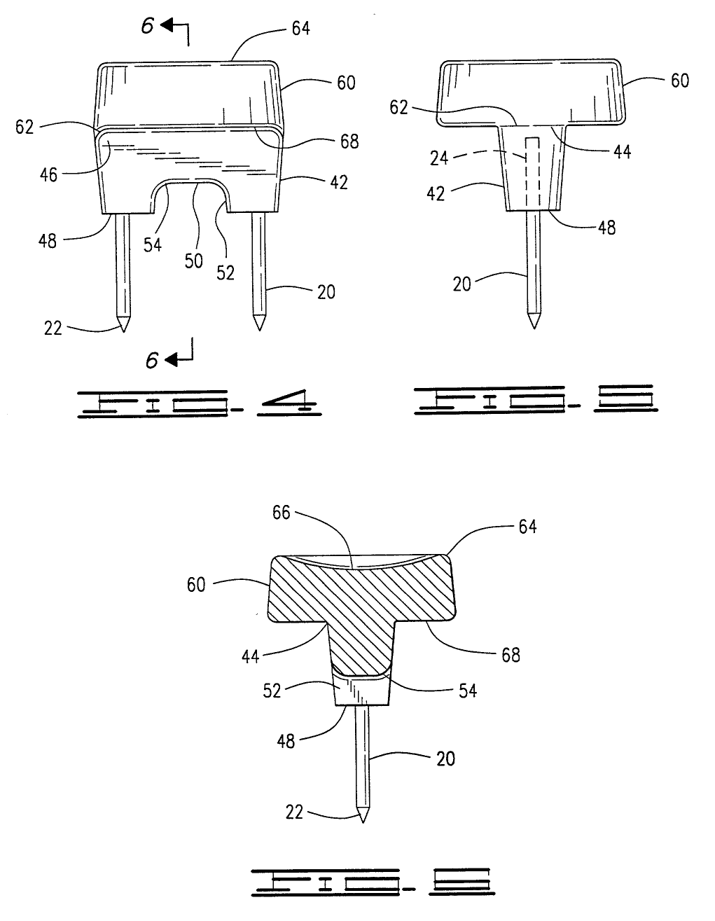

The invention, as shown in FIGS. 1-6 of the drawings, is a two pronged push tack fastening pin which can be applied to a penetrable surface to attach Christmas lighting, telephone lines, small water lines, plastic tubing, wire, cable or string to such penetrable surface, the invention comprising a pair of prong components 20 and a pin encasement component 40, the pin encasement component 40 having a pin encasement shoulders portion 42 and a pin encasement head portion 60.

Each of the prong components 20 is a single strand of rigid metal wire, having a sharp pointed terminal end 22 and a head end 24. The pin encasement shoulders portion 42 is a molded component having an upper region 44 including a pair of shoulders 46, and a lower surface 48 including an arched concave indentation 50 having two sides 52 and two edges 54. The pair of prong components 20 are placed within the lower surface 48 on each side 52 of the arched concave indentation 50, each prong component 20 having the head end 24 embedded within the lower surface 48 of the pin encasement shoulders portion 42. In a preferred embodiment, the sides 52 and the edges 54 of the arched concave indentation 50 are rounded and tapered to prevent the sides 52 and edges 54 of the arched concave indentation 50 from scoring or damaging an item placed within such arched concave indentation 50 when secured to a penetrable surface. The pair of prong components 20 should be placed in a parallel alignment.

The pin encasement head portion 60 has a lower segment 62 and an upper segment 64 containing a concave pushing surface 66. In a preferred embodiment, the pin encasement head portion 60 is oval, the concave pushing surface 66 conforming to a curvature of a human thumb. The lower segment 62 of the pin encasement head portion 60 is attached to the upper region 44 of the pin encasement shoulder portion 42.

When the invention is applied to a penetrable surface, the sharp pointed terminal ends 22 of the prong components are directed to such penetrable surface and by applying force to the concave pushing surface 66 of the pin encasement head portion 60, the two prong components 20 are forced into the penetrable surface up to the lower surface 48 of the pin encasement shoulders portion 42. The pin encasement head portion 60 should preferably be expanded beyond the pin encasement shoulders portion 42 to expose a finger grasping portion 68 of the lower segment 62 of the pin encasement head portion 60 to the grasp of the fingers of a user to aid in removal of the invention from the penetrable surface. In this regard, the preferred embodiment of the invention would have the shape of the pin encasement head portion 60 as oval and the shape of the pin encasement shoulders portion 42 as rectangular. The pin encasement shoulders portion 42 should also elevate the lower segment 62 of the pin encasement head portion 60 above the penetrable surface enough to allow the users fingers to engage the finger grasping portion 68.

In a preferred embodiment of the invention, the head end 24 of the two prong components 20 is expanded to prevent the prong components 20 from being removed from the pin encasement component 40. Another embodiment of the invention includes the two prong components 20 being connected together in a U-shape with parallel alignment of the prong components 20. The prong components 20 may also be supplied with a plurality of ridges or rings to enhance the gripping of the prong components 20 within the penetrable surface and within the pin encasement component 40.

Another use for the invention is to hang pictures or decorative items from a wall utilizing the pin encasement head portion 60 to contain a picture wire or string loop draped over the pin encasement shoulders portion 42.

While the invention has been particularly shown and described with reference to a preferred embodiment thereof, it will be understood by those skilled in the art that changes in form and detail may be made therein without departing from the spirit and scope of the invention.

What is claimed is:

1. A two pronged push tack fastening pin comprising:
a. a pin encasement component having a pin encasement head portion including a concave pushing surface and a pin encasement shoulders portion including an arched concave indentation; and
b. a pair of prong components made of rigid metal wire having sharp pointed terminal ends, such prong components extending parallel from the pin encasement shoulders portion of the pin encasement component.

2. A two pronged push tack fastening pin comprising:
a. a pin encasement component having a pin encasement head portion and a pin encasement shoulders portion; wherein the pin encasement shoulders portion is rectangular and has an upper region including a pair of shoulders and a lower surface including an arched concave indentation, such arched concave indentation having two sides and two edges and the pin encasement head portion is oval and has a lower segment and an upper segment, the upper segment containing a concave pushing surface, with the lower segment of the pin encasement head portion attaching to the upper region of the pin encasement shoulders portion, the lower segment exposing a finger grasping portion; and
b. a pair of prong components made of rigid metal wire, each prong component having a sharp pointed terminal end and a head end, the head end embedded within the lower surface of the pin encasement shoulders portion, one prong component on each side of the arched concave indentation in parallel alignment.

3. The device of claim 2, wherein the sides and edges of the arched concave indentation are rounded and tapered.
